(19) United States
(12) Patent Application Publication
(10) Pub. No.: US 2026/0163501 A1
(43) Pub. Date: Jun. 11, 2026

(54) SYNCHRONOUS ELECTRIC MACHINE AND ENHANCED CONTROL THEREOF

(71) Applicant: Multipolar Development Corporation, McCalla, AL (US)

(72) Inventor: Shaun Martin McCUTCHEON, Birmingham, AL (US)

(73) Assignee: Multipolar Development Corporation, McCalla, AL (US)

(21) Appl. No.: 18/974,055

(22) Filed: Dec. 9, 2024

(51) Int. Cl. H02P 1/48; H02P 6/10; H02P 23/14; H02P 23/20

(52) U.S. Cl. CPC H02P 1/48; H02P 6/10; H02P 23/14; H02P 23/20

(57) ABSTRACT

In some implementations, a synchronous electric machine may include multiple virtual poles and a control device. The control device may control magnetic polarities of the multiple virtual poles to create a set of effective poles. Each effect pole, included in the set of effective poles, includes one or more virtual poles of the multiple virtual poles. The control device may apply one or more input signals to the one or more virtual poles to generate a rotating magnetic field at an applied frequency.

### BACKGROUND

A synchronous machine (e.g., a synchronous AC machine), which includes both a rotor and a stator, operates by rotating the rotor at a speed of a rotating magnetic field generated by the stator, known as a synchronous speed. In these machines, the rotor is equipped with either a direct current (DC) excited winding or permanent magnets (PMs) to establish the excitation field. Additionally, the rotor includes slip rings and brushes for external connection when employing DC excitation.

The stator houses an armature winding, which remains stationary. The field winding, located on the rotor, is energized by DC to create magnetic flux in an air gap between the rotor and stator. As the rotor rotates, electromagnetic induction causes voltage to be induced in the armature winding of the stator. This induced voltage drives armature current, which in turn generates a revolving magnetic flux in the air gap. The speed of this revolving flux matches that of the rotor, which defines the synchronous operation of the machine and gives it its name as a synchronous machine. Synchronous machines typically have a fixed number of poles, which requires significant re-tooling (e.g., complete re-tooling) or replacement of an existing motor if operational requirements change that necessitate a different number of poles.

### SUMMARY

Some implementations described herein relate to a synchronous electric machine, comprising: multiple virtual poles; one or more memories; and one or more processors, communicatively coupled to the one or more memories, configured to: control magnetic polarities of the multiple virtual poles to create a set of effective poles, wherein each effective pole, included in the set of effective poles, includes one or more virtual poles of the multiple virtual poles; and apply one or more input signals to the one or more virtual poles to generate a rotating magnetic field at an applied frequency.

Some implementations described herein relate to method, comprising: determining, by a controller, a desired pole number of a synchronous electric machine, wherein the synchronous electric machine includes: multiple virtual poles; controlling, by the controller, magnetic polarities of the multiple virtual poles to create a set of effective poles, wherein each effective pole, included in the set of effective poles, includes one or more virtual poles of the multiple virtual poles; and applying, by the controller, one or more input signals to the one or more virtual poles to generate a rotating magnetic field at an applied frequency.

Some implementations described herein relate to a non-transitory computer-readable medium storing a set of instructions, the set of instructions including: one or more instructions that, when executed by one or more processors of a control device of a synchronous electric machine, cause the control device to: determine a desired pole number of the synchronous electric machine, wherein the synchronous electric machine includes multiple virtual poles; control magnetic polarities of the multiple virtual poles to create a set of effective poles, wherein each effective pole, included in the set of effective poles, includes one or more virtual poles of the multiple virtual poles; and apply one or more input signals to the one or more virtual poles to generate a rotating magnetic field at an applied frequency.

### BRIEF DESCRIPTION OF THE DRAWINGS

FIGS. 1A-1J are diagrams of an example associated with a synchronous electric machine with enhanced control, in accordance with some embodiments of the present disclosure.

FIG. 2 is a diagram of example components of a device associated with a synchronous electric machine with enhanced control, in accordance with some embodiments of the present disclosure.

FIG. 3 is a flowchart of an example process associated with a synchronous electric machine with enhanced control, in accordance with some embodiments of the present disclosure.

### DETAILED DESCRIPTION OF EXAMPLE EMBODIMENTS

The following detailed description of example implementations refers to the accompanying drawings. The same reference numbers in different drawings may identify the same or similar elements.

Typical electric machines, including line-start permanent magnet synchronous motors (LSPMSMs), wound rotor synchronous generators (WRSGs), and both induction and synchronous motors, face several distinct challenges and drawbacks. Each motor type encounters unique issues related to its design and functionality, which can complicate its application and performance. LSPMSMs and WRSGs present specific problems arising from their inherent designs, while induction and synchronous motors introduce additional complexities due to their operational characteristics and control requirements.

LSPMSMs, while offering high precision and efficiency in applications, face significant drawbacks, including limited starting torque and synchronization challenges. Limited starting torque can hinder their performance in applications requiring high initial force, and the complex electronic commutation needed for precise control complicates both start-up and operation. Similarly, WRSGs face their own set of challenges, such as requiring external mechanisms or auxiliary motors to reach synchronous speed, adding to system complexity and cost. Additionally, reducing cage bar resistance to enhance synchronization can compromise starting torque, making the motor less effective during initial start-up. The sensitivity of WRSGs to design parameters and the need for precise excitation control further complicate their integration with power systems.

In induction motors (e.g., squirrel cage induction motors), polarity changes allow rotor currents to automatically adjust to a pole number of the stator, simplifying operation. However, this automatic adjustment can limit precise control over the performance of the motor (e.g., in specific applications). For synchronous motors, changing the number of poles for both the stator and rotor simultaneously is required, which can be complex and cumbersome. A two-speed synchronous machine, designed to address these issues, incorporates a low pole number to enhance starting torque and a high pole number to improve synchronization. While this approach balances starting performance with synchronization capability, it requires careful management of the start-up process and two-pole induction torque, potentially adding to the complexity of the system and reducing operational flexibility.

Line Start Synchronous Motors (LSSMs) integrate features of both induction and synchronous motors, providing advantages such as robustness during startup and high efficiency once synchronized. However, LSSMs also face several drawbacks that impact their performance and application. For example, complexities in start-up and synchronization, limited starting torque, sensitivity to design parameters, and higher system costs.

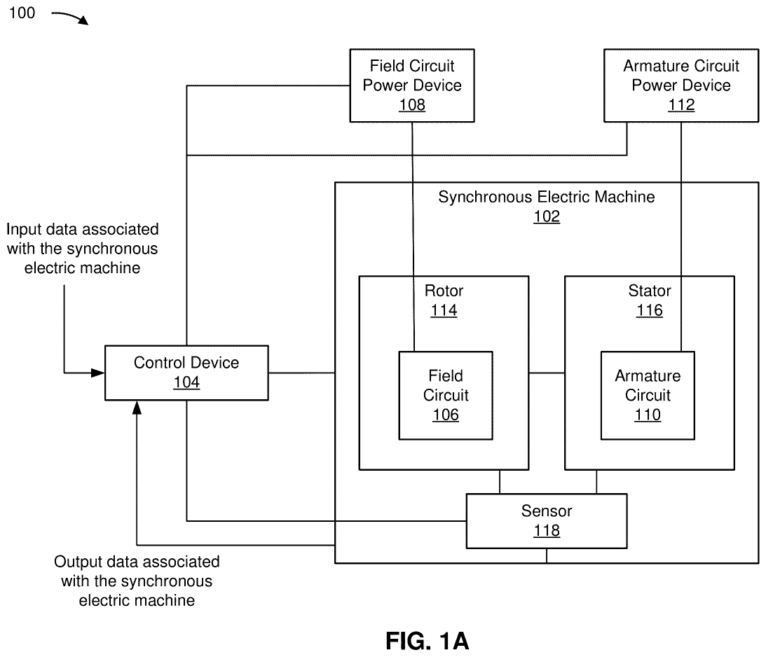

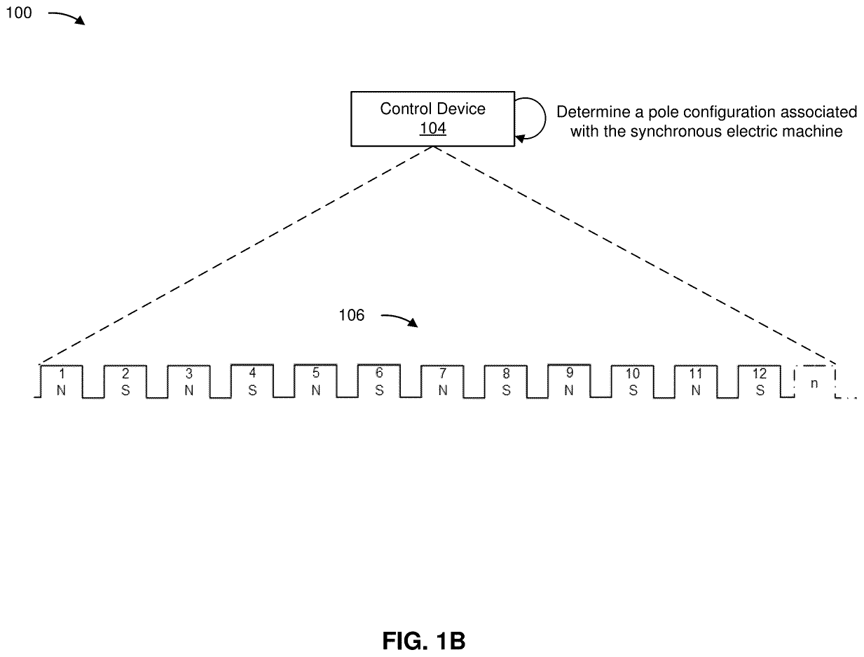

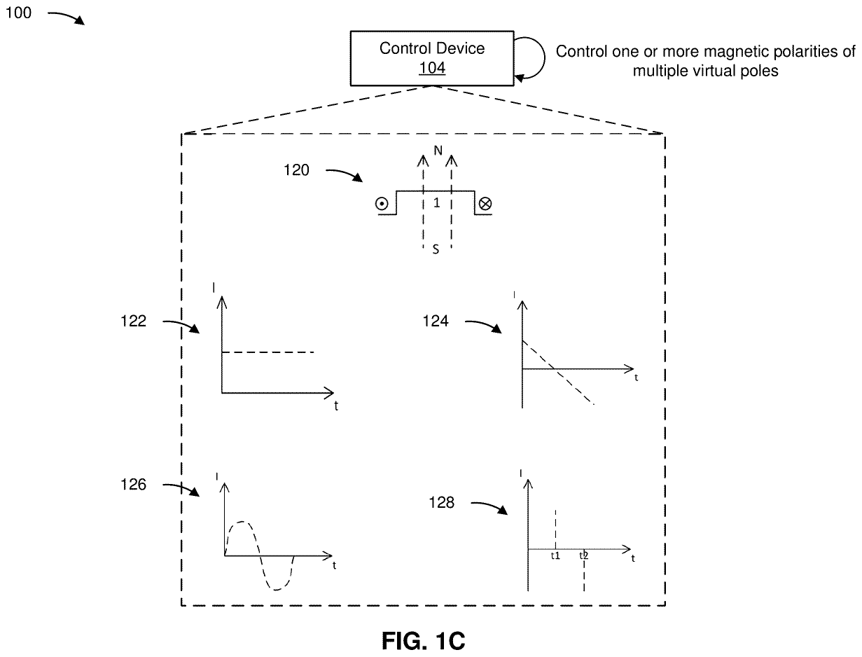

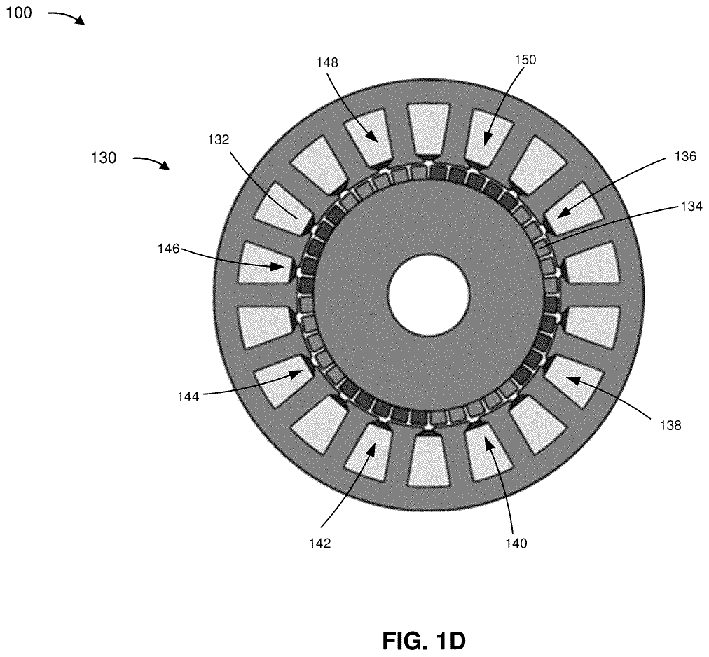

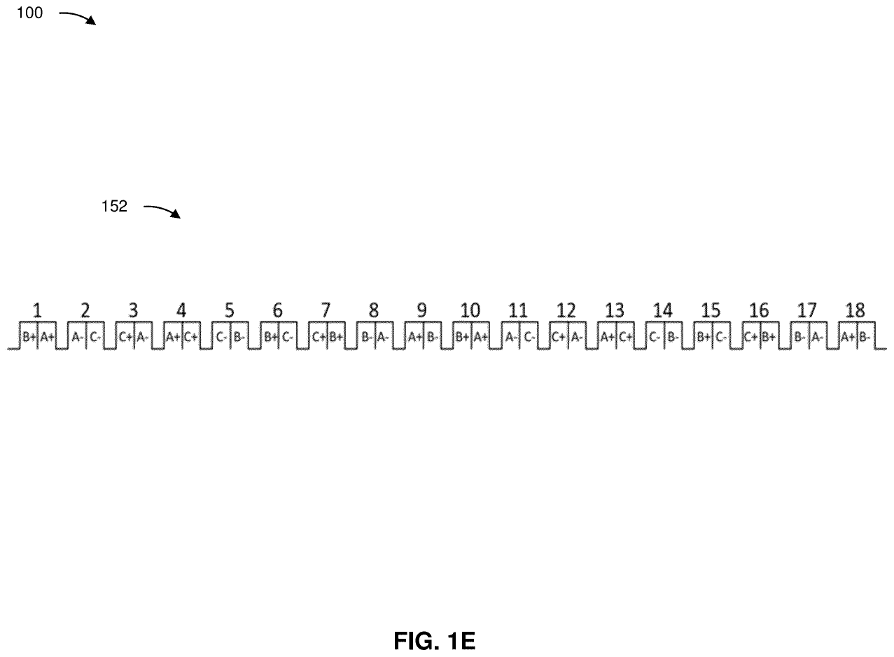

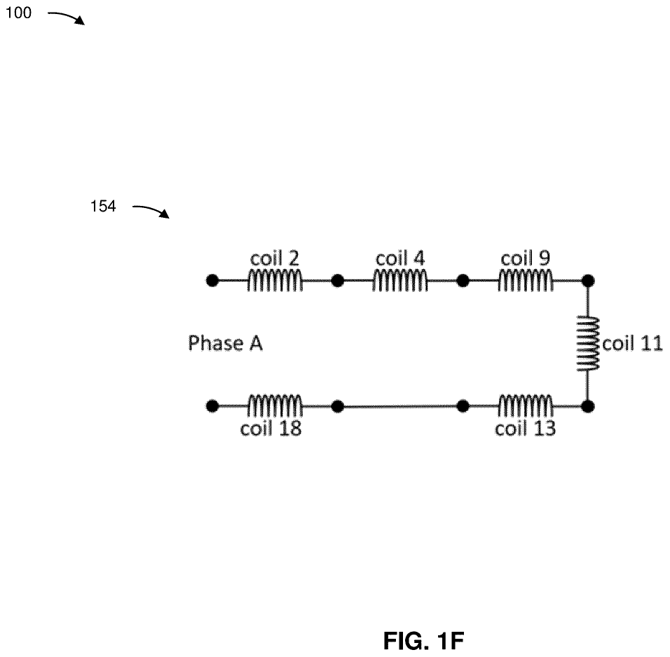

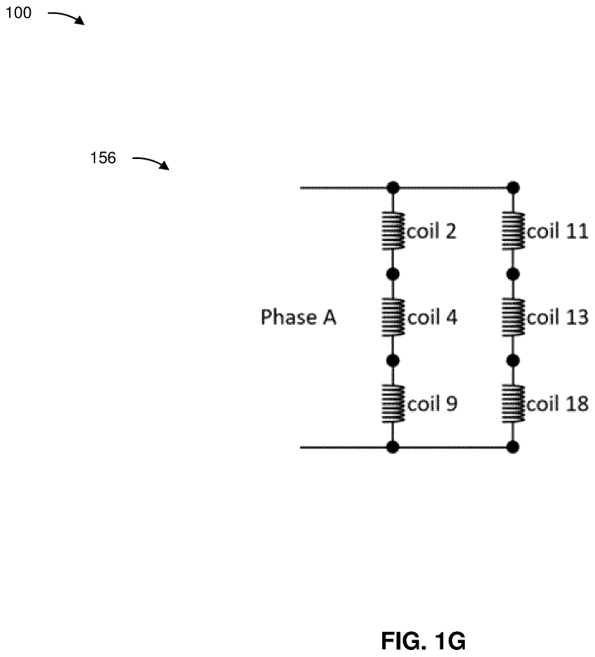

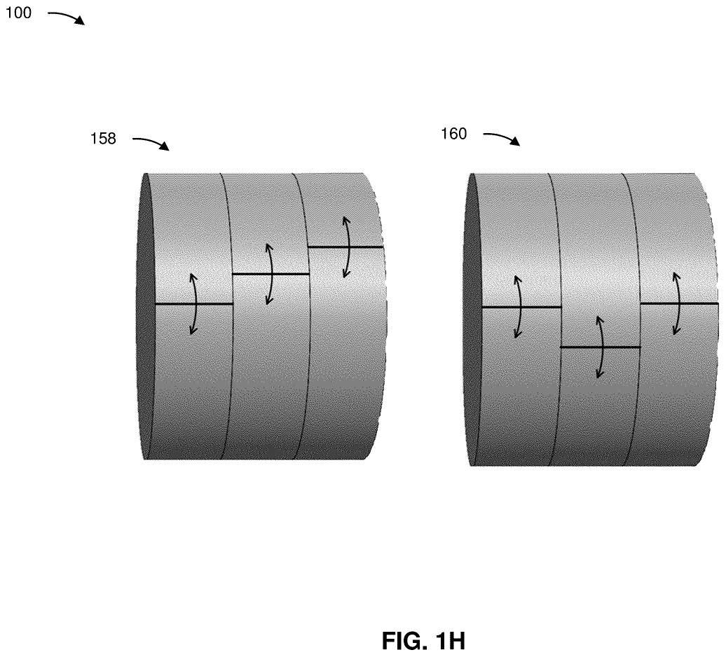

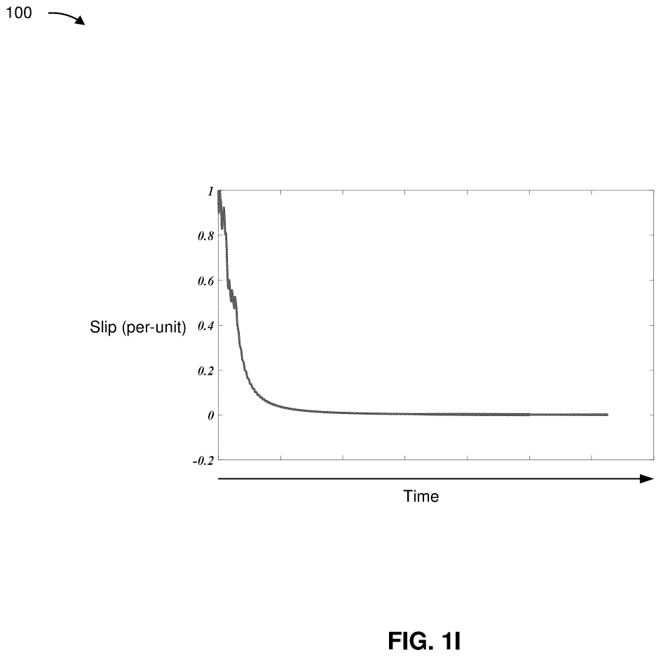

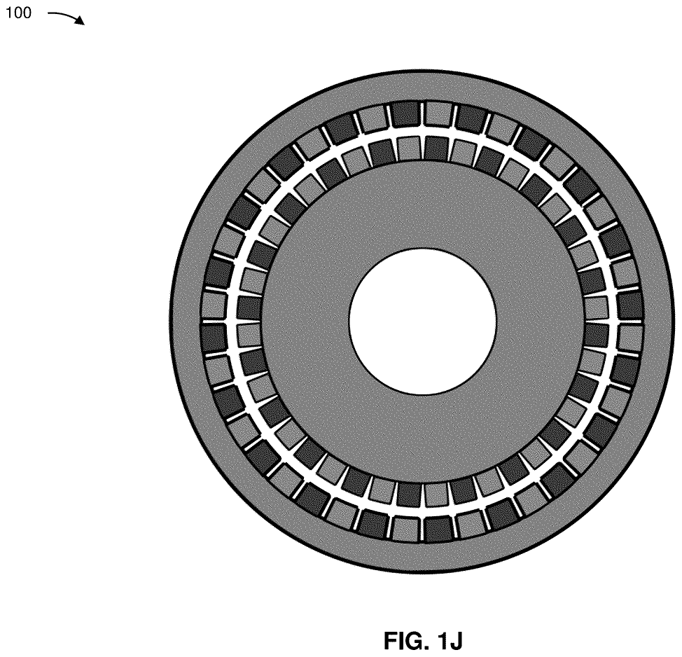

FIGS. 1A-1J are diagrams of an example 100 associated with a synchronous electric machine with enhanced control. In some implementations, the synchronous electric machine may generate rotating magnetic fields. As an examples, a rotating magnetic field in the field circuit (e.g., with versatility to adapt the rotating magnetic field based on various operation parameters, as described in more detail elsewhere herein. Generally, the synchronous electric machine may include a

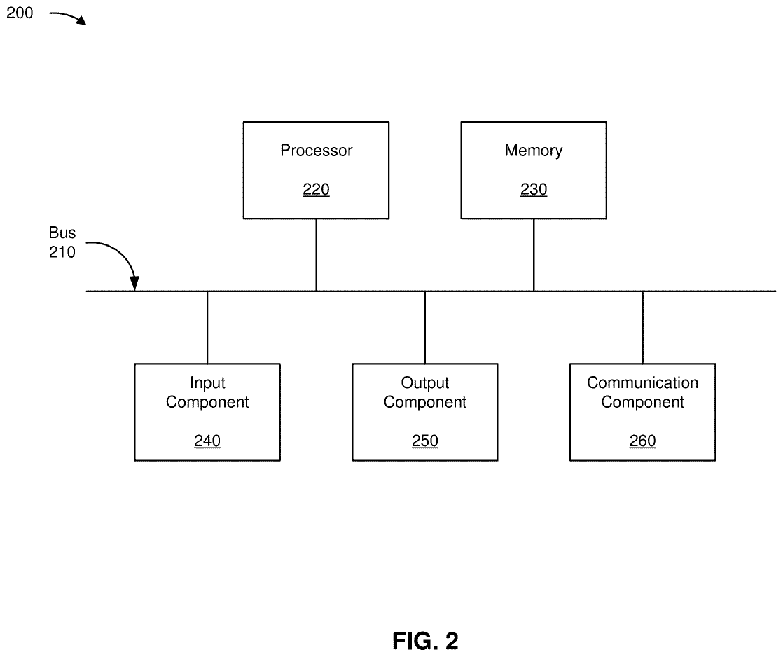

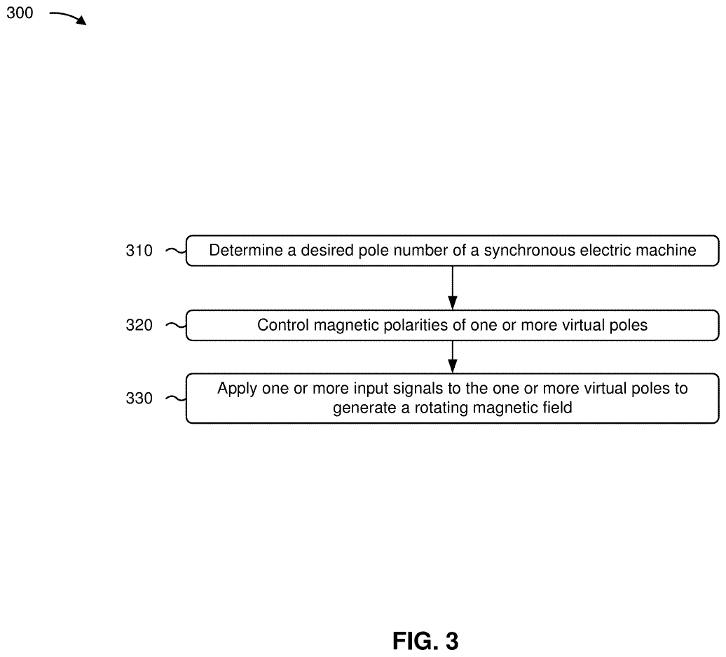

As shown in FIGS. 1A-1J, the example 100 includes a synchronous electric machine 102, a control device 104 (e.g., a pole signal control and configuration device), a field circuit 106, a field circuit power device 108, an armature circuit 110, an armature circuit power device 112, a rotor 114, a stator 116, and a sensor 118. These devices are described in more detail in connection with FIGS. 2 and 3.

Although the field circuit 106 is shown and described as being associated with the rotor 114 (e.g., the field circuit 106 is shown and described as being located or placed on the rotor 114 in connection with FIGS. 1A-1J), and the armature circuit 110 is shown and described as being associated with the stator 116 (e.g., the armature circuit 110 is shown and described as being located or placed on the stator 116 in connection with FIGS. 1A-1J), the field circuit 106 and/or the armature circuit 110 may be associated with any suitable component of the synchronous electric machine 102. For example, the field circuit 106 may be associated with the stator 116 (e.g., the field circuit 106 may be located or placed on the stator 116) and/or the armature circuit 110 may be associated with the rotor 114 (e.g., the armature circuit 110 may be located or placed on the rotor 114). Additionally, or alternatively, any suitable number of rotors, stators, field circuits, and/or armature circuits, among other examples, may be used by the synchronous electric machine 102 and/or in association with the synchronous electric machine 102.

In some implementations, the control device 104 may control a number, a magnetic strength, and/or a magnetic polarity of magnetic poles (e.g., included on the rotor 114 and/or the stator 116, as described in more detail elsewhere herein). For example, to control the number, magnetic strength, and/or the magnetic polarity of the magnetic poles, the control device 104 may control virtual poles (e.g., the field circuit 106 and/or the armature circuit 110 may include multiple virtual poles). A “virtual pole,” as described herein, is a magnetic pole (e.g., an electromagnet located in the field circuit 106 of the synchronous electric machine 102) having a controllable strength (e.g., an adjustable magnetic strength) and/or a controllable magnetic polarity (e.g., an adjustable magnetic polarity). In other words, for example, a magnetic strength and/or a magnetic polarity of a virtual pole may be independently managed (e.g., by the control device 104), as described in more detail elsewhere herein.

In some implementations, the virtual poles may be controlled (e.g., via the control device 104) between a first magnetic polarity (e.g., a north magnetic polarity N), a second magnetic polarity (e.g., a south magnetic polarity S), and a zero magnetic polarity (e.g., a null magnetic polarity). As an example, the control device 104 may control the virtual poles using a current input (e.g., a controlled constant current input, a controlled linear current input, a controlled non-linear current input, and/or a controlled impulse current input, among other examples).

In some implementations, the control device 104 may control (e.g., based on a desired pole configuration of the synchronous electric machine 102), magnetic polarities of multiple virtual poles and/or one or more armature configurations (e.g., one or more coil connection configurations, among other examples) of the armature circuit 110 to create a set (e.g., one or more sets) of effective poles. An “effective pole,” as described herein, is a magnetic pole including one or more virtual poles, of the multiple virtual poles, that have matching magnetic polarities (e.g., each virtual pole included in the set of effective poles has the same magnetic polarity) and that are associated with at least one of a synchronization, an input voltage, a startup process, a flux, a speed, a torque, and/or a power related to the synchronous electric machine 102. Accordingly, for example, each effective pole may include one virtual pole or a group of virtual poles (e.g., a group of segmented virtual poles).

The one or more armature configurations of the armature circuit 110 may be configured to support the desired pole configuration of the synchronous electric machine 102. As an example, the armature circuit 110 may include coils that are connected according to a particular pattern and/or in association with a phase of the synchronous electric machine 102 (e.g., coils per phase may be serialized, parallelized and/or disconnected based on the desired pole configuration of the electric machine), as described in more detail elsewhere herein. In this way, the control device 104 may control the magnetic polarities of the virtual poles and/or the armature configuration of the armature circuit 110 to enable a multipolar synchronous electric machine (e.g., a synchronous electric machine having a dynamically configurable pole configuration).

In some implementations, the control device 104 may be communicatively coupled to the virtual poles (e.g., the control device 104 may be communicatively coupled to each of the virtual poles). In this way, the control device 104 may selectively and independently control the virtual poles (e.g., by controlling a magnitude and/or a direction of current that flows through the virtual poles, among other examples). Accordingly, for example, the control device 104 may adjust the magnetic polarity of the virtual poles (e.g., which may be electromagnets of one or more rotors and/or electromagnets of one or more stators of the synchronous electric machine 102) such that attractive and/or repulsive forces are affected by a difference in magnetic polarity between the virtual poles, as described in more detail elsewhere herein.

As further shown in FIG. 1A, the control device 104 may receive (e.g., from the sensor 118) input data associated with the synchronous electric machine 102 (e.g., physical, mechanical, electrical, and/or electromagnetic properties associated with the synchronous electric machine 102 and/or one or more components of the synchronous electric machine 102). For example, the input data may indicate a position of the rotor 114, a number of virtual poles, a number of effective poles, positions and/or placements of the virtual poles and/or the effective poles, current information (e.g., current flowing through the virtual poles, the effective poles, one or more components of the rotor 114, and/or one or more components of the stator 116), electromotive force (EMF) information (e.g., back EMF force information associated with one or more windings of the synchronous electric machine 102), control information (e.g., control signals and/or pulse width modulation (PWM) signals), synchronization information, startup process information, voltage information (e.g., input voltage information and/or output voltage information associated with the synchronous electric machine 102 and/or one or more components of the synchronous electric machine 102), temperature information, speed information, torque information, power information, control mode information, fault detection information, and/or communication interface information, among other examples, related to the synchronous electric machine 102.

As shown in FIG. 1B, the control device 104 may determine a pole configuration associated with the synchronous electric machine 102 (e.g., based on the input data). For example, the sensor 118 may send, and the control device 104 may receive, input data indicating operational requirements (e.g., operational characteristics) related to the synchronous electric machine 102 (e.g., a synchronous speed, power supply information, a speed, a torque, and/or a power, among other examples, related to the synchronous electric machine 102). Accordingly, for example, the pole configuration (e.g., determined by the control device 104) may be based on the operational requirements. In this way, the control device 104 may dynamically control the pole number of the synchronous electric machine 102, which enables the synchronous electric machine 102 to efficiently operate using multiple different pole configurations (e.g., based on multiple and/or different operating parameters and/or requirements associated with the synchronous electric machine 102).

In some implementations, the control device 104 may control the virtual poles (e.g., located in the field circuit 106 and/or the armature circuit 110) to cause the synchronous electric machine 102 to operate with a desired pole configuration. For example, and as shown in FIG. 1B, the field circuit 106 includes n number of virtual poles that are used to control the pole configuration associated with the synchronous electric machine 102, as described in more detail elsewhere herein.

As shown in FIG. 1C, the control device 104 controls one or more magnetic polarities of multiple virtual poles (e.g., located in the field circuit 106). In some implementations, the control device 104 may control the one or more magnetic polarities by controlling a direction of current flow in the one or more virtual poles. As an example, to control a magnetic polarity of a virtual pole, the control device 104 may cause current to flow through the virtual pole in a first direction resulting in the virtual pole generating a first magnetic polarity (e.g., a north magnetic polarity N) toward a flux output of the first virtual pole, may cause current to flow through the virtual pole in a second direction (e.g., that is opposite to the first direction) resulting in the virtual pole generating a second magnetic polarity (e.g., a south magnetic polarity S) toward the flux output of the virtual pole, and/or may refrain from causing current to flow through the virtual pole resulting in the virtual pole having a zero magnetic polarity (e.g., a null magnetic polarity). In this way, the control device 104 may control the magnetic polarities of the multiple virtual poles between a first magnetic polarity, a second magnetic polarity, and a zero magnetic polarity. Furthermore, the control device 104 may control a strength of magnetic fields of the virtual poles, as described in more detail elsewhere herein.

As shown in FIG. 1C, and by reference number 120, the control device 104 causes current (e.g., an instantaneous current) to flow through the virtual pole in a direction (e.g., at a positive magnitude) that causes the virtual pole to generate a north magnetic polarity N (e.g., at a strength based on the positive magnitude) toward the flux output of the virtual pole (e.g., where the dot shown in FIG. 1C represents the instantaneous current traveling in a direction that is out of the page and where the x shown in FIG. 1C represents the instantaneous current traveling in a direction that is into the page). Accordingly, a magnetic polarity of the virtual pole, and a strength associated with the magnetic polarity, may be changed (e.g., instantaneously changed) through current input control (e.g., by the control device 104), as described in more detail elsewhere herein.

As further shown in FIG. 1C, and by reference number 122, the current input (e.g., used by the control device 104 to control the virtual poles) is a constant current input. The control device 104 causes the current to flow through the virtual pole based on a constant positive current input over a time period (e.g., where the y-axis represents a magnitude of the current and the x axis represents time t). Based on the constant positive current input, the virtual pole generates the same magnetic polarity (e.g., which depends on a direction of the flow of current through the virtual pole), at the same magnitude, toward the flux output of the virtual pole during the time period. Although the constant current input shown and described in connection with FIG. 1C and reference number 122 is a constant positive current input, the constant current input may be any suitable constant current input, such as a constant negative current input.

As further shown in FIG. 1C, and by reference number 124, the current input (e.g., used by the control device 104 to control the virtual poles) is a linear current input. The control device 104 causes current to flow in the virtual pole based on a linear function current input over a time period (e.g., where the y-axis represents the magnitude of the current and the x axis represents the time t). Based on the linear function current input, the magnetic polarity of the virtual pole is controlled between a first magnetic polarity during a first time period, a zero magnetic polarity during a second time period, and a second magnetic polarity during a third time period.

As an example, the virtual pole generates the first magnetic polarity having a strength that decreases over the first time period (e.g., based on the decreasing positive magnitude of the current), the virtual pole has a zero magnetic polarity during the second time period (e.g., based on a zero magnitude of the current), and the virtual pole generates the second magnetic polarity having a strength that decreases over the third time period (e.g., based on the negative magnitude of the current). In other words, the virtual pole will have the first magnetic polarity (based on the positive current input) with a reduced intensity over time, the zero magnetic polarity (e.g., based on the zero magnitude of the current input), and the second magnetic polarity (e.g., based on the negative current input) that increases over time in the negative direction.

As further shown in FIG. 1C, and by reference number 126, the current input (e.g., used by the control device 104 to control the virtual poles) is a non-linear current input. The control device 104 causes current to flow in the virtual pole based on a non-linear function current input over a time period (e.g., where the y-axis represents the magnitude of the current and the x axis represents the time t). Based on the non-linear function current input, the magnetic polarity of the virtual pole is controlled between a first magnetic polarity during a first time period, a zero magnetic polarity during a second time period, and a second magnetic polarity during a third time period.

As an example, the virtual pole generates the first magnetic polarity having a strength that varies over the first time (e.g., based on the varying positive magnitude of the current), the virtual pole has a zero magnetic polarity at during the second time period (e.g., based on a zero magnitude of the current), and the virtual pole generates the second magnetic polarity having a strength that varies over the third time period (e.g., based on the varying negative magnitude of the current). In other words, the virtual pole will have the first magnetic polarity (based on the positive current input) with a varying intensity over time, a zero magnetic polarity (e.g., based on the zero magnitude of the current input), and the second magnetic polarity (e.g., based on the negative current input) with a varying intensity over time.

As further shown in FIG. 1C, and by reference number 128, the current input (e.g., used by the control device 104 to control the virtual poles) is an impulse current input. The control device 104 causes current to flow in the virtual pole based on an impulse function current input at a first time period t1 and a second time period t2 (e.g., where the y-axis represents the magnitude of the current and the x axis represents the time t). Based on the impulse function current input, the magnetic polarity of the virtual pole is controlled between a first magnetic polarity during the first time period t1 and a second magnetic polarity during the second time period t2. In other words, the virtual pole will have the first magnetic polarity (based on the positive current input) with an intensity based on magnitude of the current at the first time t1, a zero magnetic polarity (e.g., based on the zero magnitude of the current input), and the second magnetic polarity (e.g., based on the negative current input) with an intensity based on the magnitude of the current at the second time t2.

FIG. 1D illustrates an example stator 130 (e.g., which may be included in the synchronous electric machine 102) including 18 stator slots (e.g., a first stator slot 132, of the 18 stator slots, is shown in FIG. 1D), 40 virtual poles (e.g., a first virtual pole 134, of the 40 virtual poles, is shown in FIG. 1D), and 8 effective poles (e.g., shown as a first effective pole 136, a second effective pole 138, a third effective pole 140, a fourth effective pole 142, a fifth effective pole 144, a sixth effective pole 146, a seventh effective pole 148 and an eighth effective pole 150 in FIG. 1D). As an example, to create the 8 effective poles, the control device 104 may control (e.g., based on a desired pole configuration of 8 poles that is based on input data received by the control device 104) polarities of the 40 virtual poles to create the 8 effective poles.

As further shown in FIG. 1D, the first effective pole 136 includes 5 virtual poles of a first magnetic polarity (e.g., a north magnetic polarity N), the second effective pole 138 includes 5 virtual poles of a second magnetic polarity (e.g., a south magnetic polarity S), the third effective pole 140 includes 5 virtual poles of the first magnetic polarity (e.g., the north magnetic polarity), the fourth effective pole 142 includes 5 virtual poles of the second magnetic polarity (e.g., the south magnetic polarity S), the fifth effective pole 144 includes 5 virtual poles of the first magnetic polarity (e.g., the north magnetic polarity N), the sixth effective pole 146 includes 5 virtual poles of the second magnetic polarity (e.g., the south magnetic polarity S), the seventh effective pole 148 includes 5 virtual poles of the first magnetic polarity (e.g., the north magnetic polarity N), and the eighth effective pole 150 includes 5 virtual poles of the second magnetic polarity (e.g., the south magnetic polarity S). Accordingly, the virtual poles of each effective pole may be associated with generating at least one of a synchronization, an input voltage, a startup process, a flux, a speed, a torque, and/or a power related to the synchronous electric machine 102.

FIG. 1E illustrates an example coil configuration 152 that may be used with the stator 130 of FIG. 1D. The coil configuration 152 includes 6 coils per phase (e.g., 6 coils for phase A, 6 coils for phase B, and 6 coils for phase C). The plus and minus signs shown in FIG. 1E represent an example terminal nomenclature for the coil connections of the coil configuration 152 of FIG. 1E. In some implementations, the coils per phase may be serialized, parallelized and/or disconnected based on the desired pole configuration.

FIG. 1F illustrates an example serialization 154 of the coils for phase A (e.g., shown as coils 2, 5, 9, 11, and 13 in FIG. 1F) of the coil configuration 152 of FIG. 1E. FIG. 1G illustrates an example parallelization 156 of the coils for phase A (e.g., shown as coils 2, 4, 9, 11, 13, and 18) of the coil configuration 152 of FIG. 1E. Although a coil configuration and coil connections are shown and described in connection with FIGS. 1D-1F, any suitable coil configuration and/or coil connections may be utilized, such as parallelization of all coil terminals in groups of one coil or two serialized coils and/or disconnection of one or more coils, among other examples. In this way, the synchronous electric machine 102 may use a flexible coil configuration that may be based on the number of effective poles in the field circuit 106 of the synchronous electric machine 102 (e.g., which may be disposed on the rotor 114 or disposed on the stator 116).

In some implementations, the synchronous electric machine 102 may control magnetic polarities of the multiple virtual poles to create a set of effective poles. Each effective pole, included in the set of effective poles, may include one or more virtual poles of the multiple virtual poles. The synchronous electric machine 102 may apply one or more input signals to the one or more virtual poles to generate a rotating magnetic field (e.g., a rotating magnetic field generated via the field circuit 106 and/or a rotating magnetic field generated via the armature circuit 110, among other examples) at an applied frequency. In some implementations, the multiple virtual poles may be included in the field circuit 106 and/or the armature circuit 110.

In some implementations, the rotating magnetic field may be a first rotating magnetic field (e.g., generated via the field circuit 106 or the armature circuit 110) that interacts with a second rotating magnetic field (e.g., generated via the field circuit 106 or the armature circuit 110) causing the rotor 114 to accelerate from standstill to a synchronous speed.

In some implementations, the applied frequency is a synchronous frequency associated with a self-starting operation of the synchronous electric machine 102. For example, the control device 104 may apply the one or more input signals to the one or more virtual poles to generate a rotating magnetic field at an applied frequency that causes the rotor 114 to accelerate from a standstill to a synchronous speed.

In some implementations, the synchronous electric machine 102 may receive data indicative of at least one of load fluctuations or load variations applied to the synchronous electric machine, and adjust, based on the at least one of the load fluctuations or the load variations, the one or more input signals applied to the one or more virtual poles to cause the rotating magnetic field to maintain rotation at a synchronous speed associated with the electric machine.

In some implementations, the synchronous electric machine 102 may receive data indicative of at least one of load ripple or torque ripple associated with the synchronous electric machine and adjust, based on the at least one of the torque ripple or the load ripple, the one or more input signals applied to the one or more virtual poles to reduce the at least one of the torque ripple or the load ripple.

In some implementations, the synchronous electric machine may include multiple rotor sections and/or multiple rotors. Positions and/or orientations associated with the multiple rotor sections and/or the multiple rotors may be adjustable and/or fixed. As an example, skew angles of the multiple rotor sections and/or the multiple rotors may be adjustable (e.g., a first configuration 158 and a second configuration 160 of adjustable rotor sections are shown in FIG. 1H) and/or may be fixed. The synchronous electric machine 102 may receive data indicative of at least one of load ripple or torque ripple associated with the synchronous electric machine and adjust, based on the at least one of the load ripple or the torque ripple, a skew angle of a rotor section, of the multiple rotor sections, to reduce the at least one of the load ripple or the torque ripple.

In some implementations, the synchronous electric machine 102 may receive a rotor position command associated with the synchronous electric machine and adjust, based on the rotor position command, a position of the rotor 114 (e.g., by adjusting a rotation step angle of the rotor 114, among other examples). As an example, the control device 104 may receive a rotor position command associated with the synchronous electric machine 102 and may adjust, based on the rotor position command, a rotation step angle of the rotor 114.

In some implementations, the synchronous electric machine 102 may include multiple stator sections and/or multiple stators. Positions and/or orientations of the multiple stator sections and/or the multiple stators may be adjustable and/or fixed. As an example, the synchronous electric machine 102 may receive data indicative of at least one of load ripple or torque ripple associated with the synchronous electric machine and adjust, based on the at least one of the load ripple or the torque ripple, a skew angle of a stator section, of the multiple stator sections, to reduce the at least one of the load ripple or the torque ripple.

In some implementations, the synchronous electric machine 102 may create the rotating magnetic field by applying (e.g., inputting via the control device 104) a periodic function that depends on a slip frequency associated with the synchronous electric machine 102, a phase angle (e.g., given by virtual pole separation), and/or a desired phase difference for magnetic field control.

In some implementations, the synchronous electric machine 102 may generate opposing rotating magnetic fields. In some implementations, the second rotating magnetic field may rotate at a synchronous speed and the synchronous electric machine 102 may (e.g., via the control device 104) determine a speed of the rotor, determine, based on the rotor speed and the synchronous speed, a slip value, and adjust, based on the slip value, the one or more input signals applied to the one or more virtual poles to synchronize the rotor speed with the synchronous speed (e.g., as shown in FIG. 1I).

In some implementations, the multiple virtual poles may be provided on the rotor 114 and the stator 116 (e.g., as shown in FIG. 1J). In this way, the synchronous electric machine 102 may control the virtual poles to operate in a similar manner as a stepper motor and/or a flux switching motor, among other examples.

As indicated above, FIGS. 1A-1J are provided as an example. Other examples may differ from what is described with regard to FIGS. 1A-1J.

FIG. 2 is a diagram of example components of a device 200 associated with a synchronous electric machine with enhanced control. The device 200 may correspond to the synchronous electric machine 102 and/or one or more components of the synchronous electric machine 102 (e.g., the control device 104, the field circuit 106, the field circuit power device 108, the armature circuit 110, the armature circuit power device 112, the rotor 114, the stator 116, and/or the sensor 118). In some implementations, the synchronous electric machine 102 and/or one or more components of the synchronous electric machine 102 (e.g., the control device 104, the field circuit 106, the field circuit power device 108, the armature circuit 110, the armature circuit power device 112, the rotor 114, the stator 116, and/or the sensor 118) may include one or more of the devices 200 and/or one or more components of the device 200. As shown in FIG. 2, the device 200 may include a bus 210, a processor 220, a memory 230, an input component 240, an output component 250, and/or a communication component 260.

The bus 210 may include one or more components that enable wired and/or wireless communication among the components of the device 200. The bus 210 may couple together two or more components of FIG. 2, such as via operative coupling, communicative coupling, electronic coupling, and/or electric coupling. For example, the bus 210 may include an electrical connection (e.g., a wire, a trace, and/or a lead) and/or a wireless bus. The processor 220 may include a central processing unit, a graphics processing unit, a microprocessor, a controller, a microcontroller, a digital signal processor, a field-programmable gate array, an application-specific integrated circuit, and/or another type of processing component. The processor 220 may be implemented in hardware, firmware, or a combination of hardware and software. In some implementations, the processor 220 may include one or more processors capable of being programmed to perform one or more operations or processes described elsewhere herein.

The memory 230 may include volatile and/or nonvolatile memory. For example, the memory 230 may include random access memory (RAM), read only memory (ROM), a hard disk drive, and/or another type of memory (e.g., a flash memory, a magnetic memory, and/or an optical memory). The memory 230 may include internal memory (e.g., RAM, ROM, or a hard disk drive) and/or removable memory (e.g., removable via a universal serial bus connection). The memory 230 may be a non-transitory computer-readable medium. The memory 230 may store information, one or more instructions, and/or software (e.g., one or more software applications) related to the operation of the device 200. In some implementations, the memory 230 may include one or more memories that are coupled (e.g., communicatively coupled) to one or more processors (e.g., the processor 220), such as via the bus 210. Communicative coupling between the processor 220 and the memory 230 may enable the processor 220 to read and/or process information stored in the memory 230 and/or to store information in the memory 230.

The input component 240 may enable the device 200 to receive input, such as user input and/or sensed input. For example, the input component 240 may include a touch screen, a keyboard, a keypad, a mouse, a button, a microphone, a switch, a sensor, a global positioning system sensor, an accelerometer, a gyroscope, and/or an actuator. The output component 250 may enable the device 200 to provide output, such as via a display, a speaker, and/or a light-emitting diode. The communication component 260 may enable the device 200 to communicate with other devices via a wired connection and/or a wireless connection. For example, the communication component 260 may include a receiver, a transmitter, a transceiver, a modem, a network interface card, and/or an antenna.

The device 200 may perform one or more operations or processes described herein. For example, a non-transitory computer-readable medium (e.g., memory 230) may store a set of instructions (e.g., one or more instructions or code) for execution by the processor 220. The processor 220 may execute the set of instructions to perform one or more operations or processes described herein. In some implementations, execution of the set of instructions, by one or more of the processors 220, causes the one or more of the processors 220 and/or the device 200 to perform one or more operations or processes described herein. In some implementations, hardwired circuitry may be used instead of or in combination with the instructions to perform one or more operations or processes described herein. Additionally, or alternatively, the processor 220 may be configured to perform one or more operations or processes described herein. Thus, implementations described herein are not limited to any specific combination of hardware circuitry and software.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

FIG. 3 is a flowchart associated with a synchronous electric machine with enhanced control. In some implementations, one or more process blocks of FIG. 3 may be performed by the synchronous electric machine 102 and/or one or more components of the synchronous electric machine 102 (e.g., the control device 104, the field circuit 106, the field circuit power device 108, the armature circuit 110, the armature circuit power device 112, the rotor 114, the stator 116, and/or the sensor 118). Additionally, or alternatively, one or more process blocks of FIG. 3 may be performed by one or more components of the device 200, such as the processor 220, the memory 230, the input component 240, the output component 250, and/or the communication component 260.

As shown in FIG. 3, the process 300 includes determining a desired pole number of a synchronous electric machine (block 310). For example, the control device 104 may determine a desired pole number of the synchronous electric machine 102, as described in more detail elsewhere herein. In some implementations, the synchronous electric machine 102 may include multiple virtual poles.

As further shown in FIG. 3, the process 300 includes controlling magnetic polarities of virtual poles (block 320). For example, the control device 104 may control magnetic polarities of the multiple virtual poles to create a set of effective virtual poles, as described in more detail elsewhere herein. In some implementations, each effective pole, included in the set of effective poles, includes one or more virtual poles of the multiple virtual poles.

As further shown in FIG. 3, the process 300 includes applying one or more input signals to the one or more virtual poles to generate a rotating magnetic field (block 330). For example, the control device 104 may apply one or more input signals to the one or more virtual poles to generate a rotating magnetic field at an applied frequency, as described in more detail elsewhere herein.

In some implementations, the synchronous electric machine 102 further includes a field circuit and an armature circuit. The multiple virtual poles may be included in at least one of the field circuit or the armature circuit. In some implementations, the rotating magnetic field may be a first rotating magnetic field that interacts with a second rotating magnetic field causing the rotor 114 to accelerate from standstill to a synchronous speed.

In some implementations, a controller (e.g., the control device 104) may determine a speed of the rotor 114 and may determine, based on the rotor speed and the synchronous speed, a slip value. The controller may adjust, based on the slip value, the one or more input signals applied to the one or more virtual poles to synchronize a rotor speed with the synchronous speed.

In some implementations, the applied frequency may be associated with a self-starting operation of the synchronous electric machine. In some implementations, the applied frequency may be a synchronous frequency, and the controller may receive data indicative of at least one of load fluctuations or load variations applied to the synchronous electric machine. The controller may adjust, based on the at least one of the load fluctuations or the load variations, the one or more input signals applied to the one or more virtual poles to cause the rotating magnetic field to maintain rotation at a synchronous speed associated with the synchronous electric machine.

In some implementations, the controller may receive data indicative of at least one of load ripple or torque ripple associated with the synchronous electric machine. The controller may adjust, based on the at least one of the torque ripple or the load ripple, the one or more input signals applied to the one or more virtual poles to reduce the at least one of the torque ripple or the load ripple.

In some implementations, the controller may receive a rotor position command associated with the synchronous electric machine. The controller may adjust, based on the rotor position command, a position of the rotor 114 (e.g., by adjusting a rotation step angle of the rotor 114, among other examples).

Although FIG. 3 shows example blocks of the process 300, in some implementations, the process 300 may include additional blocks, fewer blocks, different blocks, or differently arranged blocks than those depicted in FIG. 3. Additionally, or alternatively, two or more of the blocks of the process 300 may be performed in parallel. The process 300 is an example of one process that may be performed by one or more devices described herein. These one or more devices may perform one or more other processes based on operations described herein, such as the operations described in connection with FIGS. 1A-1J. Moreover, while the process 300 has been described in relation to the devices and components of the preceding figures, the process 300 can be performed using alternative, additional, or fewer devices and/or components. Thus, the process 300 is not limited to being performed with the example devices, components, hardware, and software explicitly enumerated in the preceding figures.

The foregoing disclosure provides illustration and description but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A synchronous electric machine, comprising:
multiple virtual poles;
one or more memories; and
one or more processors, communicatively coupled to the one or more memories, configured to:
control magnetic polarities of the multiple virtual poles to create a set of effective poles,
wherein each effective pole, included in the set of effective poles, includes one or more virtual poles of the multiple virtual poles; and
apply one or more input signals to the one or more virtual poles to generate a rotating magnetic field at an applied frequency.

2. The synchronous electric machine of claim 1, further comprising:
a field circuit; and
an armature circuit,
wherein the multiple virtual poles are included in at least one of the field circuit or the armature circuit.

3. The synchronous electric machine of claim 1, wherein the rotating magnetic field is a first rotating magnetic field,
wherein the synchronous electric machine further includes a rotor, and
wherein the first rotating magnetic field interacts with a second rotating magnetic field causing the rotor to accelerate from standstill to a synchronous speed.

4. The synchronous electric machine of claim 3, wherein the one or more processors are further configured to:
determine a speed of the rotor;
determine, based on the rotor speed and the synchronous speed, a slip value; and
adjust, based on the slip value, the one or more input signals applied to the one or more virtual poles to synchronize the rotor speed with the synchronous speed.

5. The synchronous electric machine of claim 1, wherein the applied frequency is associated with a self-starting operation of the synchronous electric machine.

6. The synchronous electric machine of claim 1, wherein the applied frequency is a synchronous frequency, and
wherein the one or more processors are further configured to:
receive data indicative of at least one of load fluctuations or load variations applied to the synchronous electric machine; and
adjust, based on the at least one of the load fluctuations or the load variations, the one or more input signals applied to the one or more virtual poles to cause the rotating magnetic field to maintain rotation at a synchronous speed associated with the electric machine.

7. The synchronous electric machine of claim 1, wherein the one or more processors are further configured to:
receive data indicative of at least one of load ripple or torque ripple associated with the synchronous electric machine; and
adjust, based on the at least one of the torque ripple or the load ripple, the one or more input signals applied to the one or more virtual poles to reduce the at least one of the torque ripple or the load ripple.

8. The synchronous electric machine of claim 1, wherein the synchronous electric machine further includes multiple rotor sections, and
wherein the one or more processors are further configured to:
receive data indicative of at least one of load ripple or torque ripple associated with the synchronous electric machine; and
adjust, based on the at least one of the load ripple or the torque ripple, a skew angle of a rotor section, of the multiple rotor sections, to reduce the at least one of the load ripple or the torque ripple.

9. The synchronous electric machine of claim 1, wherein the synchronous electric machine further includes multiple stator sections, and
wherein the one or more processors are further configured to:
receive data indicative of at least one of load ripple or torque ripple associated with the synchronous electric machine; and
adjust, based on the at least one of the load ripple or the torque ripple, a skew angle of a stator section, of the multiple stator sections, to reduce the at least one of the load ripple or the torque ripple.

10. The synchronous electric machine of claim 1, wherein the synchronous electric machine further includes a rotor, and
wherein the one or more processors are further configured to:
receive a rotor position command associated with the synchronous electric machine; and
adjust, based on the rotor position command, a rotation step angle of the rotor.

11. A method, comprising:
determining, by a controller, a desired pole number of a synchronous electric machine,
wherein the synchronous electric machine includes:
multiple virtual poles;
controlling, by the controller, magnetic polarities of the multiple virtual poles to create a set of effective poles,
wherein each effective pole, included in the set of effective poles, includes one or more virtual poles of the multiple virtual poles; and
applying, by the controller, one or more input signals to the one or more virtual poles to generate a rotating magnetic field at an applied frequency.

12. The method of claim 11, wherein the synchronous electric machine further includes:
a field circuit; and
an armature circuit,
wherein the multiple virtual poles are included in at least one of the field circuit or the armature circuit.

13. The method of claim 11, wherein the rotating magnetic field is a first rotating magnetic field,
wherein the synchronous electric machine further includes a rotor, and
wherein the first rotating magnetic field interacts with a second rotating magnetic field causing the rotor to accelerate from standstill to a synchronous speed.

14. The method of claim 13, wherein the method further comprises:
determining, by the controller, a speed of the rotor;
determining, by the controller and based on the rotor speed and the synchronous speed, a slip value; and
adjusting, by the controller and based on the slip value, the one or more input signals applied to the one or more virtual poles to synchronize the rotor speed with the synchronous speed.

15. The method of claim 11, wherein the applied frequency is associated with a self-starting operation of the synchronous electric machine.

16. The method of claim 11, wherein the applied frequency is a synchronous frequency, and
wherein the method further comprises:
receiving, by the controller, data indicative of at least one of load fluctuations or load variations applied to the synchronous electric machine; and
adjusting, by the controller and based on the at least one of the load fluctuations or the load variations, the one or more input signals applied to the one or more virtual poles to cause the rotating magnetic field to maintain rotation at a synchronous speed associated with the synchronous electric machine.

17. The method of claim 11, wherein the method further comprises:
receiving, by the controller, data indicative of at least one of load ripple or torque ripple associated with the synchronous electric machine; and
adjusting, by the controller and based on the at least one of the torque ripple or the load ripple, the one or more input signals applied to the one or more virtual poles to reduce the at least one of the torque ripple or the load ripple.

18. A non-transitory computer-readable medium storing a set of instructions, the set of instructions comprising:
one or more instructions that, when executed by one or more processors of a synchronous electric machine, cause the synchronous electric machine to:
determine a desired pole number of the synchronous electric machine,
wherein the synchronous electric machine includes multiple virtual poles;
control magnetic polarities of the multiple virtual poles to create a set of effective poles,
wherein each effective pole, included in the set of effective poles, includes one or more virtual poles of the multiple virtual poles; and
apply one or more input signals to the one or more virtual poles to generate a rotating magnetic field at an applied frequency.

19. The non-transitory computer-readable medium of claim 18, wherein the synchronous electric machine further includes a field circuit and an armature circuit, and
wherein the multiple virtual poles are included in at least one of the field circuit or the armature circuit.

20. The non-transitory computer-readable medium of claim 18, wherein the rotating magnetic field is a first rotating magnetic field,
wherein the synchronous electric machine further includes a rotor, and
wherein the first rotating magnetic field interacts with a second rotating magnetic field causing the rotor to accelerate from standstill to a synchronous speed.
